(19) United States
(12) Patent Application Publication
(10) Pub. No.: US 2009/0228463 A1
(43) Pub. Date: Sep. 10, 2009

(54) Method for Searching Compound Databases Using Topomeric Shape Descriptors and Pharmacophoric Features Identified by a Comparative Molecular Field Analysis (CoMFA) Utilizing Topomeric Alignment of Molecular Fragments

(76) Inventors: Richard D. Cramer, Santa Fe, NM (US); Brian Campbell, St. Charles, MO (US)

Correspondence Address: LAURENCE A WEINBERGER, ESQ., 429 EXTON COMMONS, EXTON, PA, 19341, US

(21) Appl. No.: 12/045,511

(22) Filed: Mar. 10, 2008

(51) Int. Cl. G06F 7/06; G06F 17/30

(52) U.S. Cl. 707/4; 707/E17.024

(57) ABSTRACT

A CoMFA 3D QSAR shape analysis may be performed on molecules arising from the same activity series that may be decomposed/viewed as assemblies of discrete identifiable subunits. The disclosed method provides for identifying in databases of whole molecules those molecular subunits that possess the same shape or shape and feature characteristics as the subunits of molecules used to perform the CoMFA analysis. Additionally, the method provides for estimation of the likely biological activity of molecules assembled from the subunits identified in the molecular database.

### BACKGROUND OF INVENTION

1. Field of the Invention

This invention relates to a method for performing the CoMFA 3D QSAR shape analysis methodology on molecules arising from the same activity series that may be decomposed/viewed as assemblies of discrete identifiable subunits and further provides for identifying in heterogeneous databases of whole molecules those molecular subunits that possess the same shape or shape and feature characteristics as the molecular subunits used to perform the CoMFA analysis. Additionally, the method provides for estimation of the likely biological activity of molecules assembled from the subunits identified in the molecular database.

2. Description of Related Art

In U.S. Pat. No. 5,025,388 and U.S. Pat. No. 5,307,287 Comparative Molecular Field Analysis (CoMFA), a three-dimensional quantitative structure activity relationship (3D QSAR) technique was introduced. The CoMFA technique permits a quantitative correlation of the observed activities of several molecules in the same biological assay to the shape characteristics of those molecules. Each molecule is aligned in a three dimensional grid and its shape characterized by the steric and electrostatic interactions energies between a probe and the atoms of the molecule at each grid point. The interaction energies are associated with the observed/measured activity of the molecule in a CoMFA table and a partial least squares (PLS) statistical analysis with validation is performed.

The resulting analysis provides coefficients of each grid location term in the table that reflects that position's contribution to the observed activity. Using the data, it is possible to identify and observe those volumes of the molecule (arrangement of atoms) associated with either increased or decreased activity. Based on the identified coefficients, it is also possible to estimate the likely biological activity of a molecule for which no activity has yet been determined in an assay. CoMFA requires great care in the selection of molecular conformations and the proper alignment of the series of molecules, but, nevertheless, the technique demonstrated the power of utilizing three dimensional shape descriptors in molecular analysis, and it has become a fundamental method in computational chemistry with well over 5,000 citations to its use.

The use of three dimensional shape descriptors utilizing metric fields was subsequently expanded to include comparison of the shapes of constituent parts of molecules (fragments/structural variations) in U.S. Pat. No. 6,185,506. There it was first shown that the validity of a molecular structural descriptor could be demonstrated across multiple biological activities by employing the Patterson plot methodology that also yields a neighborhood distance characteristic of the descriptor. Further, a solution to the problem of identifying a generally appropriate molecular conformation was achieved. A rule-based alignment (topomeric alignment) for molecular parts/fragments/structural variations is demonstrated which generates a uniform pose. The shape of the molecular part is characterized, as in CoMFA, by a field of interaction energies calculated between a probe and the atoms in the aligned molecular part at each point in a three dimensional grid surrounding the molecular part. The steric interaction energies are principally used although, in the appropriate circumstances, electrostatic interaction energies may be added. Although the rule based topomeric alignment may be arbitrary and unlikely for any particular molecule, the field shape descriptor of the topomeric alignments was shown to be a valid molecular structural descriptor by means of the Patterson plot method. Using descriptors having an associated neighborhood distance, molecules could be identified which shared shape characteristics in a way, which was meaningfully related to their biological activity. In this patent, the shape descriptor was utilized to efficiently design screening libraries.

U.S. Pat. No. 6,240,374 taught how to use the topomeric shape descriptor to compare the shape of fragments derived from biologically active compounds to the shapes of fragments derived from compounds that could be utilized in combinatorial library synthesis. It was demonstrated that a compound with known activity could be fragmented into smaller pieces following a set of fragmentation rules. The fragments can be topomerically aligned and their shapes represented by the steric interaction fields. The shape of fragments derived from molecules that could be used in combinatorial syntheses were similarly characterized and stored in a virtual library of component parts. Comparison of the shapes of fragments derived from known active compounds to the shapes of component parts in the virtual library identified those component parts that could be used to substitute in a molecule for the fragment from the known active. All possible product molecules that could be combinatorially derived from the component parts can be searched for shapes similar to the known active without the necessity of generating the product structures during the search by searching through only a combination of the descriptors of the component parts. This patent also taught the incorporation of pharmacophoric “feature” information into the topomeric shape descriptions.

In U.S. Pat. No. 7,330,793 a method was taught that enabled the search of databases of compounds, in which the compounds might or might not share any common synthetic lineage, for compounds that might possess a biological activity similar to that of a known compound. Compounds in the databases were identified based on the similarity of their three dimensional shape to the three dimensional shape of the known compound using the shape responsive metric that had been validated as correlating to biological activity; that is, similarity in three dimensional shape as measured by the metric correlated with similarity in biological activity.

In this method, the compound with known activity was fragmented into smaller pieces following a set of fragmentation rules. Each individual fragment was aligned according to the rule based procedure—the topomer alignment procedure—and placed into a three dimensional grid. As before, the shape of the topomer aligned fragments was characterized by the steric interaction energies at each grid intersection between a probe and each of the fragment atoms. In succession, each compound in a database was fragmented, the fragments topomerically aligned, and the shape characterized by the steric interaction energies. Shape comparison was again achieved by calculating the root sum of squares difference between the interaction energies at each point in the grid. A smaller value indicating a closer shape similarity. The patent taught the application of this method for compounds (both known and database) having differing numbers of fragments. In addition, the patent taught methods for handling cores resulting from dividing the candidate compounds into three or more fragments. Pharmacophor feature information could be included in the shape descriptions.

The use of shape descriptors of topomerically aligned molecular fragments derived from molecules having activity in the same biological assay to perform a comparative molecular field analysis is disclosed in U.S. Pat. No. 7,329,222 (TopCoMFA). The method is applicable to molecules that may be decomposed/viewed as assemblies of discrete identifiable subunits/fragments that have an open valence bond/position. Each such fragment is aligned according to the rule based topomeric alignment procedure and the electrostatic and steric interaction fields determined. As in standard CoMFA the relevant measured molecular parameter (typically activity) is represented as a linear combination of 3D shape descriptors. Unlike standard CoMFA that uses the interaction fields about the entire molecule, in TopCoMFA only the interaction fields about the subunits/fragments are used. The TopCoMFA data table associates the electrostatic and steric interaction energies of each derived fragment from each molecule in a row of the data table.

A Partial Least Squares (PLS) analysis using a cyclic cross-validation procedure is employed to extract a set of coefficients for each column position (lattice point) that reflects that positions contribution to the measured activity. The column coefficients can be used as in standard CoMFA to predict the likely activity of a molecule not present in the activity series used to generate the CoMFA model. In this case, the molecule is decomposed in a manner similar to the decomposition applied to the molecules of the activity series and the fragments are topomerically aligned and the field values calculated. Multiplying the field values by the coefficients associated with each point yields the predicted activity for the molecule.

Standard CoMFA models indicated volumes about a molecule where changes may result in greater or lesser activity but leave up to chemists to propose suggestions for molecular alterations that take advantage of the model information. A major advance of TopCoMFA is the ability to identify substitute molecular structures that could be substituted for the fragments derived from the initial activity series. Not only can substitute fragments be identified, but their likely activity can be predicted from the TopCoMFA model. To accomplish this, the average steric interaction energies at each lattice location of corresponding fragments derived from the molecules in the initial activity series are used to search a Virtual Library (described earlier) for fragments that have similar 3D shapes. These identified fragments can be substituted for their corresponding fragments in the activity series. Thus, TopCoMFA provides a method to suggest alternative molecular structures that are likely to possess the same activity as those molecules in the initial activity series. Further, the steric and electrostatic interaction energies about the topomerically aligned identified fragments, when multiplied by the corresponding TopCoMFA coefficients, produce predicted activities for the new molecular structures without the necessity of synthesis. TopCoMFA analysis has speeded up lead optimization in drug discovery.

### BRIEF DESCRIPTION OF THE FIGURE

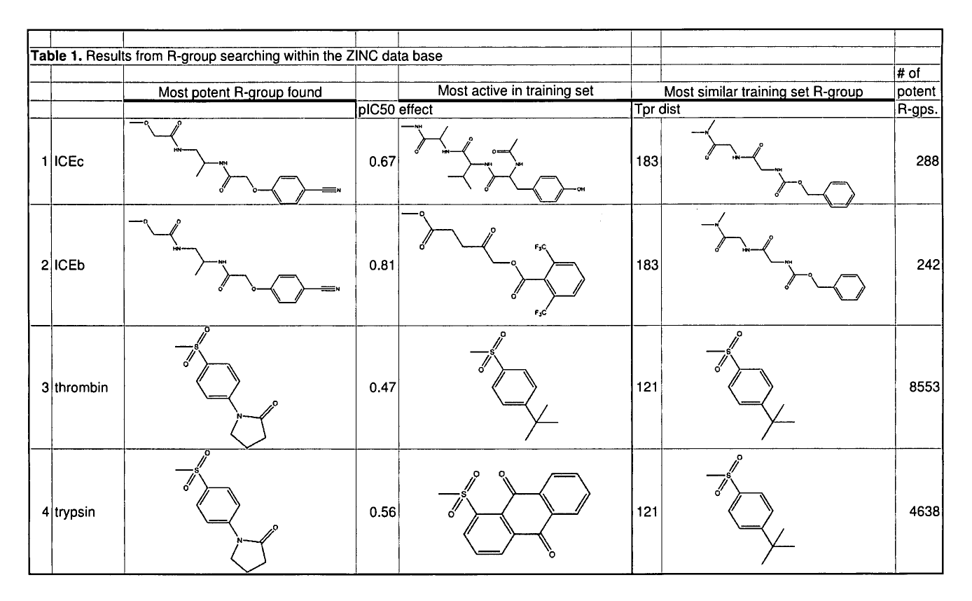

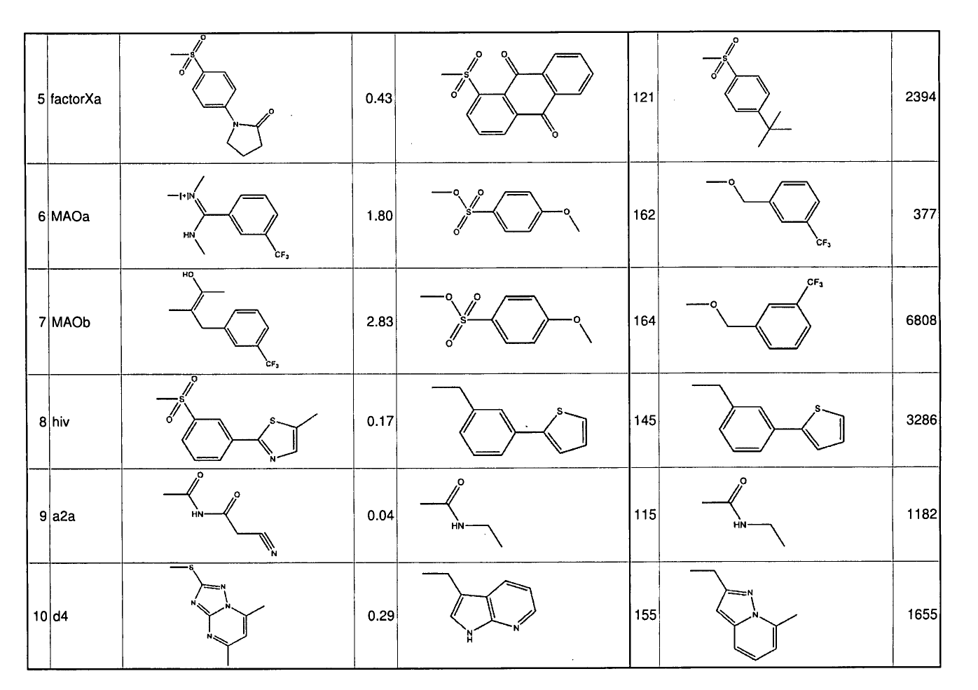

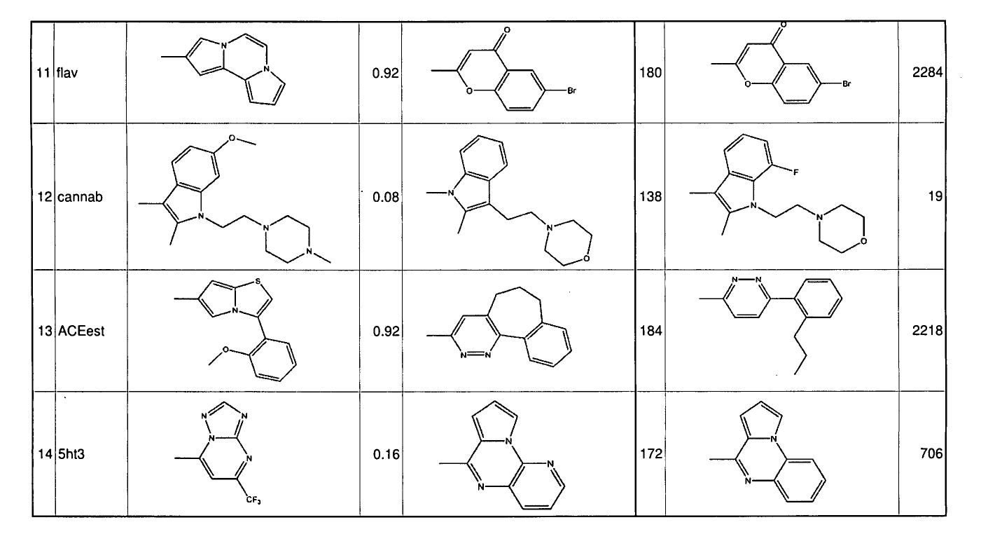

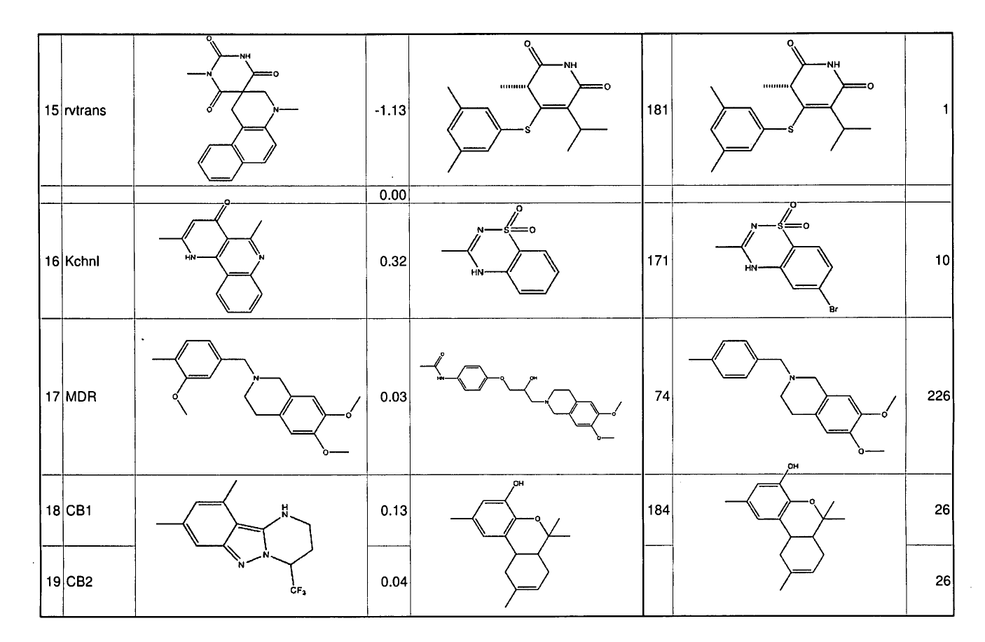

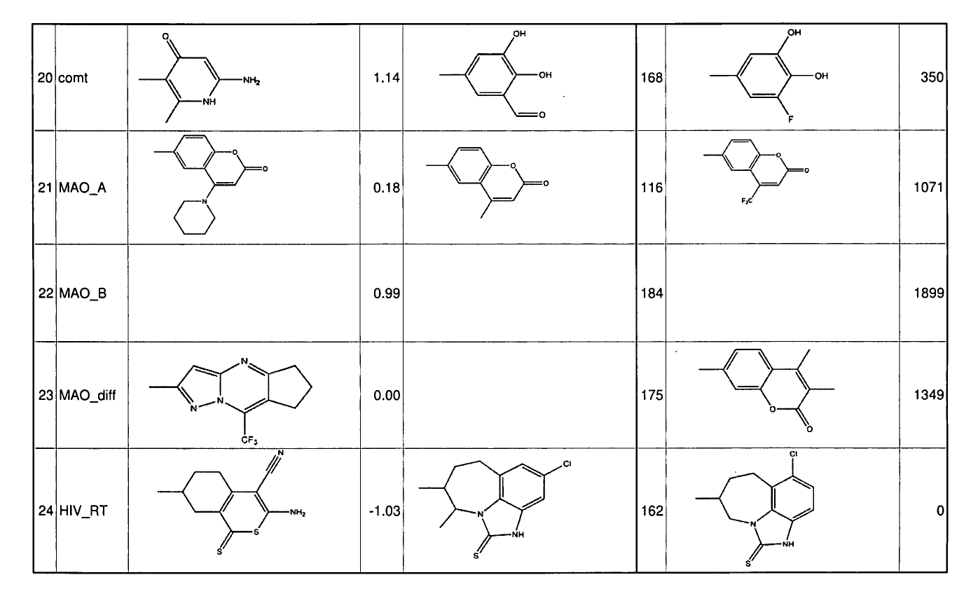

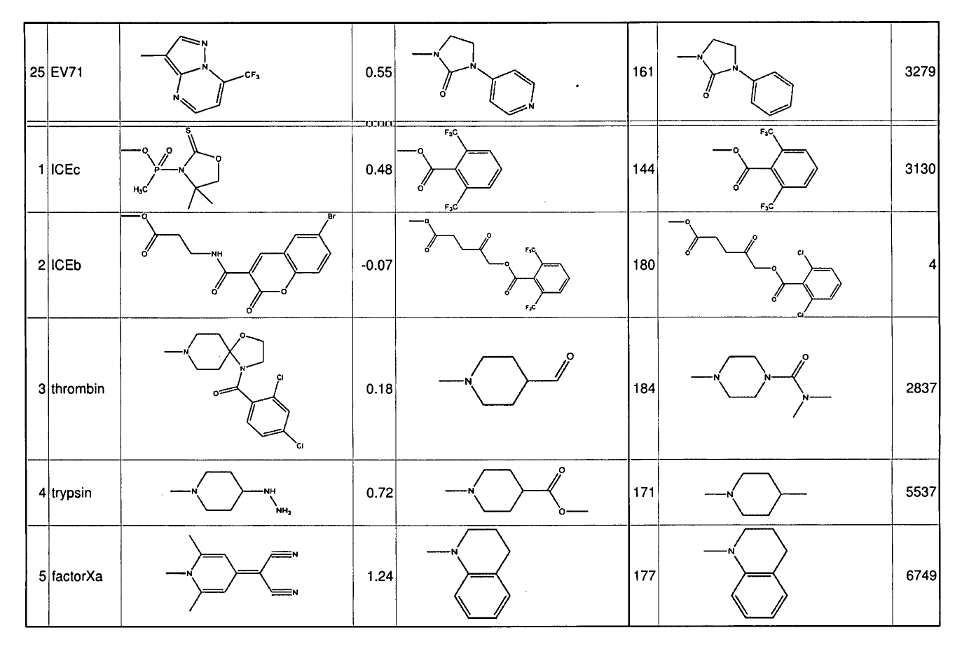

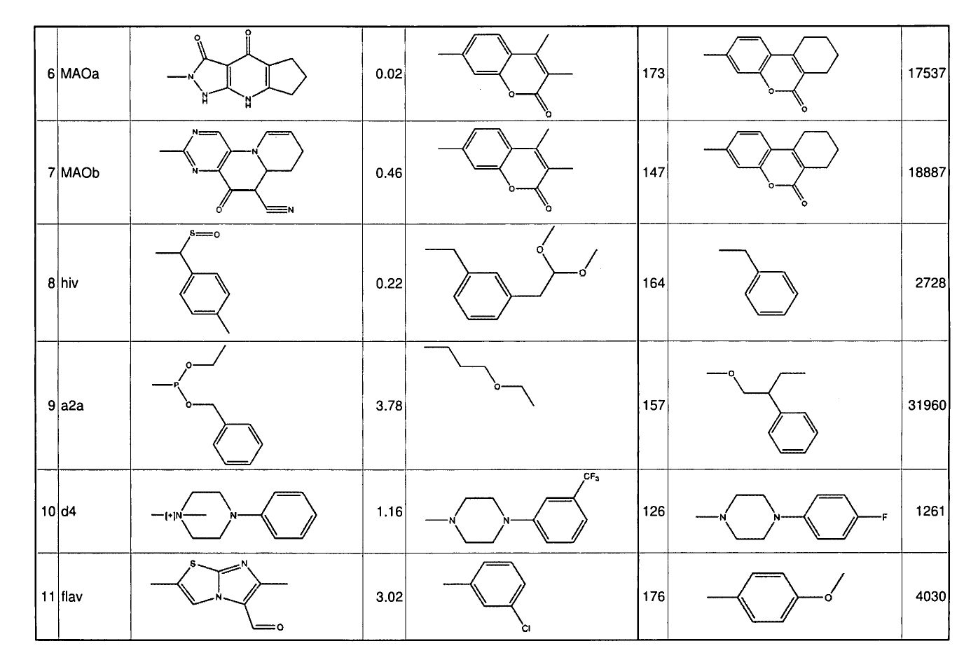

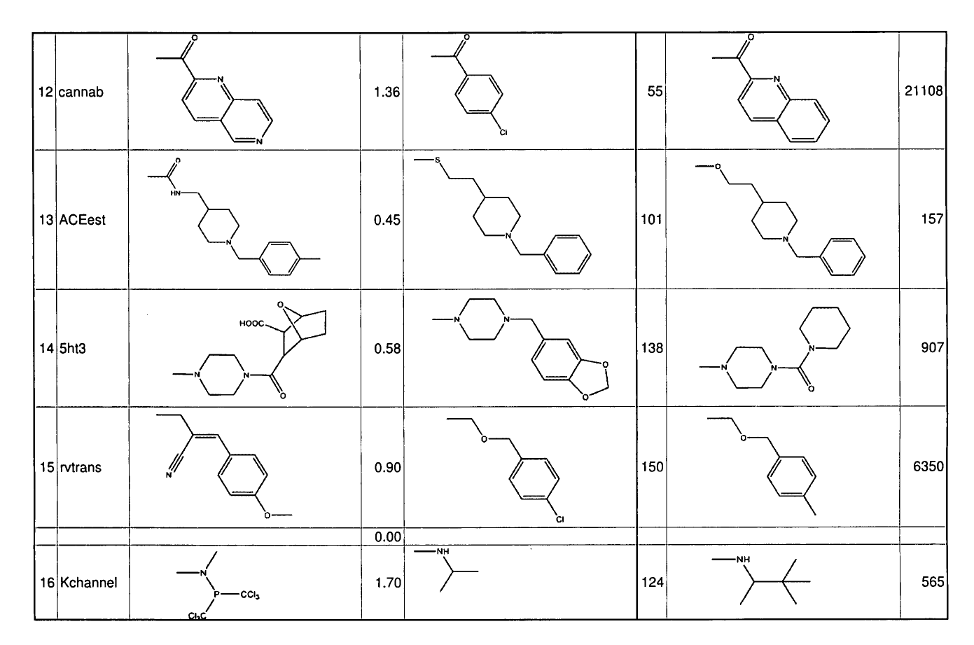

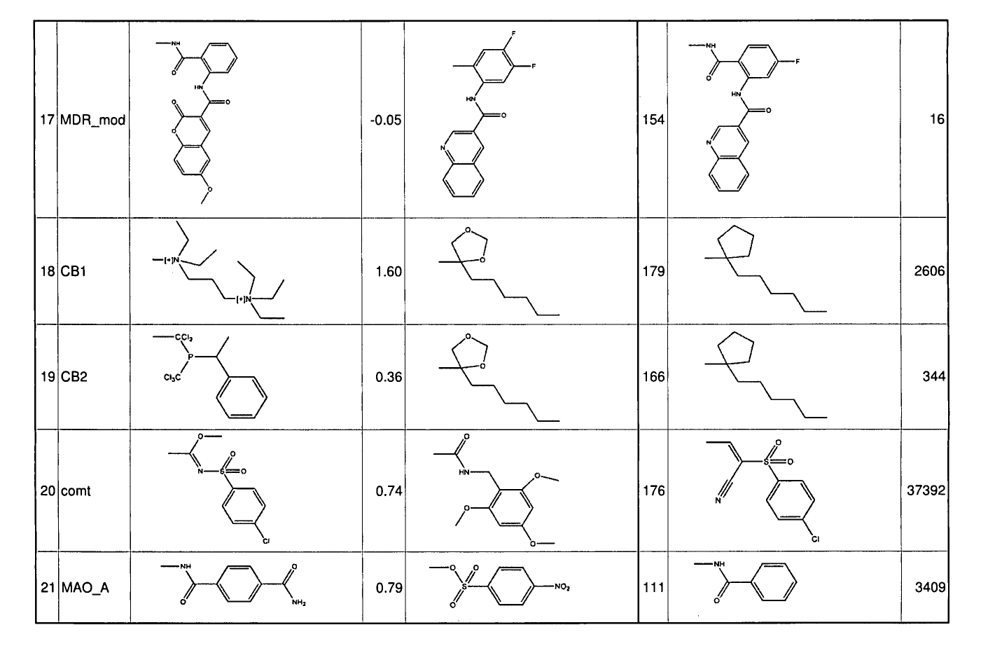

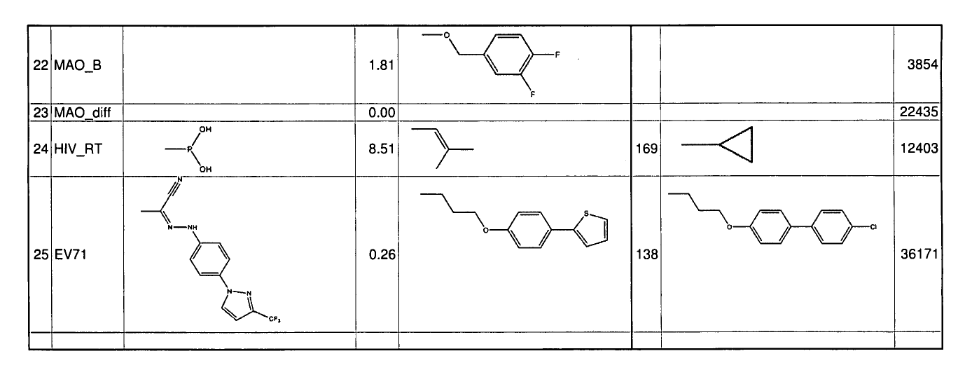

FIG. 1 displays the result of applying the method of the present invention to a search of the heterogeneous compound database ZINC:
First column: a serial ID number.
Second column: a shorthand name identifier (not necessarily unique).
Third column: shows the most potent R-group within ZINC that had the highest predicted pIC50 contribution
Fifth column: Shows the most active R-group in the training set
Fourth column: shows the amount by which the pIC50 of the third column structure exceeds the pIC50 of the column five structure
Seventh column: shows the R group in the training set that is most topomerically similar to the structure in the third column
Sixth column: shows the topomeric distance between the structures in columns three and seven
Eigth column: shows the count of all R-groups found within ZINC that are “highly potent”, where “highly potent” is greater than the top 25% of the experimental potency range. (Thus if the potency range is between 5.8 and 1.0, the count would be for structures having a predicted pIC50 higher than 4.6.)

### DETAILED DESCRIPTION OF THE INVENTION

The complete specifications including the attached software code of the U.S. patents cited in the background section (U.S. Pat. Nos. 5,025,388, 5,307,287, 6,185,506, 6,240,374, 7,330,793, and 7,329,222) are incorporated into this patent document as if fully set forth herein.

### Definitions:

Consistent with the use of terminology as it developed in the above incorporated patents, the following definitions are used in this patent document.

“Standard CoMFA” shall mean a comparative molecular field analysis performed using the steric and electrostatic fields of aligned whole molecules as taught in U.S. Pat. No. 5,025,388 and U.S. Pat. No. 5,307,287

“Topomeric CoMFA” shall mean a comparative molecular field analysis performed using the steric and electrostatic fields of topomerically aligned fragments as taught in U.S. Pat. No. 7,329,222.

“Fragment” shall mean a chemical structure having an open valence (attachment bond) at one or more positions. Any part of a chemical structure which can be (computationally) severed from the remaining structure so as to have one or more open valences (partial/attachment bonds) can be considered as a fragment. Fragments are a useful way to deconstruct the three dimensional shape of molecules.

“Virtual Library” shall mean a database library of characterized fragments derived from available commercial reagents that can be used in a combinatorial synthesis of compounds and can be said to be homogeneous in that sense.

“Heterogeneous Library” shall mean large assemblages of available molecules that can be commercially obtained. These assemblages/libraries are not the result of any particular combinatorial synthesis but rather represent the assembly of a wide range of molecules from many different sources and syntheses, some known, some unknown. These libraries may, and do typically, contain natural products. Therefore, these assemblages/libraries of molecules can be characterized as heterogeneous.

### Description:

As noted in the background:

1) U.S. Pat. No. 6,240,374 taught that fragments derived from an active molecule could be used to search a homogeneous Virtual Library for fragments having similar shapes. Those library fragments could then be assembled into product molecules;

2) U.S. Pat. No. 7,330,793 taught that fragments derived from an active molecule could be used to search a heterogeneous library for fragments having similar shapes and a new molecule assembled from those identified fragments; and

3) U.S. Pat. No. 7,329,222 taught that fragments derived from the molecules active in the same assay could be used to generate a CoMFA model. A representative fragment shape could then be used to search a homogeneous Virtual Library to identify fragments having similar shapes, and the CoMFA model coefficients used to predict the activity of a molecule assembled from the identified fragments.

Given the well known unpredictability of pharmacological drug discovery, prior to the referenced patent disclosures the prior art did not anticipate that computer aided drug design could advance lead discovery as it has now been shown to do. In particular, nothing suggested that molecular fragments could be used to generate and use a CoMFA model as taught in U.S. Pat. No. 7,329,222. However, the variety of fragment shapes available in a homogeneous library nowhere approximates the variety of fragment shapes found in the chemical universe of available compounds (heterogeneous libraries) much less those that are synthetically accessible. It was not at all clear that the results of a fragment generated topomeric CoMFA could be used to identify similarly shaped fragments in the molecules of a heterogeneous library (treating the library compounds as an assemblage of fragments) and to predict with any accuracy the likely activities of molecules assembled from the identified fragments. The presence in a heterogeneous library of the much greater shape variety of molecular fragments including those from natural product sources made such an expectation unpredictable.

The method described in this patent document achieves the goal of employing topomeric CoMFA with a heterogeneous library to further aid drug discovery. To achieve this remarkable result, the method disclosed in U.S. Pat. No. 7,329,222 was extended. First, as earlier, fragmentation rules adopted by the user are employed. Prior to topomeric alignment, Concord is used to generate the three dimensional structure of each fragment. Pharmacophoric features are included in the topomerically aligned fragments as appropriate - both with those fragments derived from molecules in the activity series, as well as with fragments derived from the compounds in the heterogeneous library. The same probe is applied to all fragments to generate the steric and electrostatic interaction energies. To generate a CoMFA model, fragments are placed in a CoMFA table as before.

PLS analysis of the CoMFA data table proceeds as in U.S. Pat. No. 7,329,222. The inventors have found a further refinement useful. In the PLS cross-validation cycle, identical fragments are excluded rather than whole molecules as in standard CoMFA. For example, suppose for two-part fragmentation of 4 active molecules, the fragments are identified as follows:

| | | |
|---|---|---|
| Molecule 1: | A | B |
| Molecule 2: | C | D |
| Molecule 3: | E | F |
| Molecule 4: | G | H |

If fragments A and E were identical, one of the cross-validation runs would omit both A and E with the resulting model then being based only on fragments B and F. Similarly, if fragments D and H were identical, they would be ignored in a cross-validation round, but fragments C and G would be retained in the analysis. The leave out one R-group (LOORG) procedure takes as input a topomer CoMFA, including its underlying R-group fragments representing each individual compound tested, and iterating through every R-group position. The first action in iteration is to assemble a list of all the structural variations the data set contains for that R-group position. That list is then traversed, with the following steps applied to each of the R-groups in turn.

1) all the tested compounds having that R-group are omitted;

2) a topomer CoMFA is derived from the resulting SAR table;

3) the resulting topomer CoMFA equation is used to predict the activities of the omitted compounds; and

4) those activity predictions are recorded, becoming the fundamental LOORG results When all R-group positions have thus been processed, the procedure ends.

It has been found that a CoMFA model (coefficients of the column terms that represent the relative contributions of the various lattice positions to the biological activity) generated in this manner is extraordinarily useful with heterogeneous libraries.

In the method of U.S. Pat. No. 7,329,222, the average steric interaction energies about each fragment (for fragments derived from the same position in the active molecules) was used as the shape criterion to search the homogeneous library. Given the rapidity with which library searches may be conducted, it has now been found that a different approach may be employed with both homogeneous and heterogeneous libraries. At the user's discretion, one or more of all the fragments derived from the active series molecules can be used to search for fragments similar in shape (and pharmacophoric features—as applicable). Each library molecule is taken up in order, fragmented, topomerically aligned, fields calculated, and a shape comparison performed. (As disclosed in the cited patents, the root sum of squares difference in steric field values is used as a measure of shape similarity.) The neighborhood distance associated with the metric of steric field values around topomerically aligned fragments is used to decide whether a fragment is sufficiently close in shape to be retained for further analysis.

Each identified fragment from the library is placed in its appropriate column position (corresponding to the active molecule fragment to which it is shape similar) and the CoMFA model coefficients associated with both the steric and electrostatic terms are used to multiply the steric and electrostatic values associated with the identified fragments. This procedure is followed for all possible combinations of library identified fragments to predict an activity for molecules containing every combination of fragments. The most active molecules that can be formed are thus identified. It has been the inventors' experience that molecules can be identified by assembling the fragments found in the heterogeneous library that have a higher predicted activity than the compounds that formed the active series used in the topomeric CoMFA analysis.

The results of performing a topomeric CoMFA analysis may be output in a variety of ways, as taught in the cited patents, depending on the requirements of the user. For instance, using the topomeric CoMFA column coefficients the volumes around the fragments where changes contributing to either increased or decreased activity can be visually displayed. The column coefficients can also be used to predict the likely activity of molecules left out of the active series training set or of molecular structural changes suggested by experienced chemists. Again, for every such prediction, the volumes about the fragments can be visually displayed.

The results of a search of a heterogeneous database can also be output/displayed in a variety of formats. FIG. 1 shows one method of displaying the results of performing a topomeric CoMFA and database search on the ZINC database. (ZINC is a heterogeneous database of commercially available compounds.) Twenty-five sets of active molecules covering many different activities for which a standard CoMFA analysis had been performed where examined by the method of this invention. Identification of the data sets is set out under “References”. (These sets were chosen so that the results of the topomeric CoMFA analysis could be compared to the standard CoMFA results. Over all the sets, the results of the topomeric CoMFA were substantially equivalent to the standard CoMFA results.) A two-part fragmentation was applied to each of the molecules in the various activity series. FIG. 1 lists 50 fragments, 25 from fragmentation at a first position (an R1 group) and 25 from fragmentation at a second position (an R2 group). Of course, which group is designated as R1 or R2 is arbitrary. The structures of the fragments used for the search as well as those fragments identified in the database are displayed along with associated data related to the search.

In column three are shown the fragments identified from the ZINC database that are identified as being most potent for each activity series in the training sets at both fragment positions. The values in the pIC50 column are the differences between the potency of the identified fragment and the potency of the most potent fragment in the training set used to generate the topomeric CoMFA for that series. As can be seen in the pIC50 results in the fourth column, the potency of virtually all the ZINC database identified fragments is greater than the potency of the most active fragment found in the training set. Thus, it can be seen that, by identifying those fragments that can be used to increase the potency of known compounds, the method of this invention dramatically provides an avenue of lead optimization not before possible.

For comparison, the fifth column displays the structure of the most active fragment in the training set at the same fragment position (being the one for which the difference in pIC50 is calculated). In the seventh column, the structure of the fragment in the training set most similar to the ZINC database identified fragment is shown. The topomeric neighborhood distance between those structures in shown in column 6. It is important to realize that while the structure in the seventh column is within the metric's neighborhood distance of the ZINC identified structure, the most active structure identified in the ZINC database is identified by the structure activity relationship trend (topomeric CoMFA) characteristic of all compounds in the training set, not just one compound.

Finally, the eighth column contains the number of highly potent R groups (for that fragment position) identified in the ZINC database. These are all fragments that are at least 25% as active as the fragments in the corresponding training set series. The method of this invention provides for the first time an avenue to identify not only the most potent fragment but also a range of molecular structures that are potent at the fragment position.

### Computational Chemistry Environment

Generally, all calculations and analyses to decompose molecules into fragments, to topomerically align fragments, to calculate electrostatic and steric interaction energies, to perform topomeric CoMFA utilizing the fragment energies, to search for similar molecular shapes in a compound database, and to predict activities of possible molecules are implemented in a modern computational chemistry environment using software designed to handle molecular structures and associated properties and operations. For purposes of the present application, such an environment is specifically referenced. In particular, the computational environment and capabilities of the SYBYL and UNITY software programs developed and marketed by Tripos, Inc. (St. Louis, Mo.) are specifically utilized. Software with similar functionalities to SYBYL and UNITY are available from other sources, both commercial and non-commercial, well known to those in the art. Software to practice standard CoMFA may be commercially licensed from Tripos, Inc. as part of SYBYL. The required CoMFA software code was also disclosed as part of U.S. Pat. No. 5,025,388 and U.S. Pat. No. 5,307,287. Software to perform topomeric fragment alignments and compute their steric fields was disclosed as part of U.S. Pat. No. 6,185,506. Software to perform topomeric fragment alignments of chiral fragments and to generate and search a Virtual Library of molecular components was disclosed as part of U.S. Pat. No. 6,240,374. Software to search a heterogeneous database of compounds was disclosed in U.S. Pat. No. 7,330,793. Software to perform a topomeric CoMFA analysis was disclosed in U.S. Pat. No. 7,329,222. Not all the software code provided in the cited patents is required to practice the method of the present invention. (As an example, code providing for the calculation of Tanimoto metric values is not required.)

A general-purpose programmable digital computer (such as one running the Linux operating system) with ample amounts of memory and hard disk storage is required for the implementation of this invention. In performing the methods of this invention, representations of thousands of molecules and molecular structures as well as other data may need to be stored simultaneously in the random access memory of the computer or in rapidly available permanent storage. As the size of the searched heterogeneous database increases, a corresponding increase in hard disk storage and computational power is required.

### REFERENCES

1. Kulkami, S. S.; Kulkarni, V. M. Three-Dimensional Quantitative Structure-Activity Relationship of Interleukin 1-b Converting Enzyme Inhibitors: A Comparative Molecular Field Analysis Study. J. Med. Chem. 1999, 42, 373-380.
2. Bohm, M.; Sturtzebecher, J.; Klebe, G. Three-Dimensional Quantitative Structure-Activity Relationship Analyses Using Comparative Molecular Field Analysis and Comparative Molecular Similarity Indices Analysis To Elucidate Selectivity Differences of Inhibitors Binding to Trypsin, Thrombin, and Factor Xa. .J. Med. Chem. 1999, 42, 458-477.
3. Gnerre, C.; Catto, M.; Leonetti, F.; Weber, P.; Carrupt, P.-A.; Altomare, C.; Carotti, A.; Testa, B. Inhibition of Monoamine Oxidase by Functionalized Coumarin Derivatives: Biological Activities, QSARs, and 3D-QSARs. J. Med. Chem. 2000, 43, 4747-4752.
4. Schaal, W.; Karlsson, A.; Ahlsen, G.; Lindberg, J.; Andersson, H. O.; Danielson, U. H.; Classon, B.; Unge, T.; Samuelsson, B.; Hulten, J.; Hallberg, A.; Karlen, A. Synthesis and Comparative Molecular Field Analysis (CoMFA) of Symmetric and Nonsymmetric Cyclic Sulfamide HIV-1 Protease Inhibitors. J. Med. Chem. 2001, 44, 155-169.
5. Rieger, J. M.; Brown, M. L.; Sullivan, G. W.; Linden, J.; Macdonald, T. L. Design, Synthesis, and Evaluation of Novel A2A Adenosine Receptor Agonists. J. Med. Chem. 2001, 44, 531-539.
6. Lanig, H.; Utz, W.; Gmeiner, P. Comparative Molecular Field Analysis of Dopamine D4 Receptor Antagonists Including 3-[4-(4-Chlorophenyl)piperazin-1-ylmethyl]pyrazolo[1,5-a]pyridine (FAUC 113), 3-[4-(4-Chlorophenyl)piperazin-1-ylmethyl]-1H-pyrrolo-[2,3-b]pyridine (L-745,870), and Clozapine. J. Med. Chem. 2001, 44, 1151-1157.
7. Huang, X.; Liu, T.; Gu, J.; Luo, X.; Ji, R.; Cao, Y.; Xue, H.; Wong, J. T.-F.; Wong, B. L.; Jiang, H.; Chen, K. 3D-QSAR Model of Flavonoids Binding at Benzodiazepine Site in GABAA Receptors. J. Med. Chem. 2001, 44, 1883-1891.
8. Tetko, I. V.; Kovalishyn, V. V.; Livingstone, D. J. Volume Learning Algorithm Artifical Neural Networks for 3D QSAR Studies. J. Med. Chem. 2001, 44, 2411-2420.
9. Sippl, W.; Contreras, J.-M.; Parrot, I.; Rival, Y. M.; Wermuth, C. G. Structure-based 3D QSAR and design of novel acetylcholinesterase inhibitors. J. Comp.-Aided Mol. Des. 2001, 15, 395-410.
10. Bureau, R.; Daveu, C.; Baglin, I.; Santos, J. S.-D.; Lancelot. J.-C.; Rault, S. Association of Two 3D QSAR Analyses. Application to the Study of Partial Agonist Serotonin-3 Ligands. . J. Chem. Inf. Comput. Sci. 2001, 41, 815-823.
11. Hannongbua, S.; Nivesanond, K.; Lawtrakul, L.; Pungpo, P.; Wolschann, P. 3D-Quantitative Structure-Activity Relationships of HEPT Derivatives as HIV-1 Reverse Transcriptase Inhibitors, Based on Ab-Initio Calculations. J. Chem. Inf. Comput. Sci. 2001, 41, 848-855. De Tullio, P.; Dupont, L.; Francotte, P.; Counerotte, S.; Lebrun, P.; Pirotte, B. Three-Dimensional Quantitative Structure-Activity Relationships of ATP-Sensitive Potassium (KATP) Channel Openers Belonging to the 3-Alkylamino-4H-1,2,4-benzo- and 3-Alkylamino-4H-1,2,4-pyridothiazine 1,1,-Dioxide Families. J. Med. Chem. 2006, 49, 6779-6788.
12. Labrie, P.; Maddaford, S. P.; Fortin, S.; Rakhit, S.; Kotra, L. P.; Gaudreault, R. C. A Comparative Molecular Field Analysis (CoMFA) and Comparative Molecular Similarity Analysis (CoMSIA) of Anthranilamide Derivatives That Are Multidrug Resistant. J. Med. Chem. 2006, 49, 7646-7660.
13. Durdagi, S.; Kapou, A.; Kourouli, T.; Andreou, T.; Nikas, S. P.; Nahmias, V. R.; Papahatjis, D. P.; Papadopoulos, M. G.; Mavronmoustakos, M. The Application of 3D-QSAR Studies for Novel Cannabinoid Ligands Substituted at the C1 Position of the Alkyl Side Chain on the Structural Requirements for Binding to Cannabinoid Receptors CB1 and CB2. J. Med. Chem. 2007, 50, 2875-2885.
14. Tervo, A. J.; Nyronen, T. H.; Ronkko, T.; Poso, A. A structure-activity relationship study of catechol-O-methyltranferase inhibitors combining molecular docking and 3D QSAR methods. J. Comp.-Aided Mol. Des.. 2003, 17, 797-810.
15. Catto, M.; Nicolotti, O.; Leonetti, F.; Carotti, A.; Favia, A. D.; Soto-Otero, R,; Mendez-Alvarez, E.; Carotti, A. Structural Insights into Monoamine Oxidase Inhibitory Potency and Selectivity of 7-Substituted Coumarins from Ligand- and Target-Based Approaches. J. Med. Chem. 2006, 49, 4912-4925.
16. Zhou, Z.; Madura, J. D. CoMFA 3D-QSAR Analysis of HIV-1 RT Nonnucleoside Inhibitors, TIBO Derivatives Based on Docking Conformation and Alignment. J. Chem. Inf. Comput. Sci. 2004, 44, 2167-2178.
17. Ke, Y.-Y.; Lin, T.-H. Modeling the Ligand-Receptor Interaction for a Series of Inhibitors of the Capsid Protein of Entovirus 71 Using Several Three-Dimensional Quantitative Structure-Activity Relationship Techniques. J. Med. Chem. 2006, 49, 4517-4525.

We claim:

1. A computer implemented method for identifying fragments from a heterogeneous compound database which are likely to share the same type of activity as fragments derived from molecules identified as sharing that activity, comprising the steps of:
(a) fragmenting the molecules in the series according to a consistent procedure;
(b) topomerically aligning each fragment according to a defined set of rules;
(c) calculating steric and electrostatic field descriptor values for the topomerically aligned fragments;
(d) entering the field descriptor values in a CoMFA table wherein the field descriptors for each fragment are associated with the unique parameter value for the molecule from which the fragment was derived;
(e) analyzing the table with the CoMFA methodology to derive a 3D CoMFA QSAR model generating coefficients of each field descriptor value in the 3D CoMFA QSAR table;
(f) using the steric field values of the fragments in the CoMFA table, searching a heterogeneous compound database for fragments, the database compounds similarly fragmented and the fragments topomerically aligned and characterised by steric and electrosatic field descriptors, to identify those fragments having shapes similar to the fragments used to generate the 3D CoMFA QSAR; and
(g) determining the likely activity of fragments identified as being similar in shape by determining the likely activity for each fragment by multiplying the steric and electrostatic field values for each fragment by the 3D CoMFA QSAR coefficients of the similarly positioned fragments derived from molecules in the initial activity series.

2. A computer implemented method for identifying fragments from a heterogeneous compound database which are likely to share the same type of activity as fragments derived from molecules identified as sharing that activity, comprising the steps of:
(a) fragmenting the molecules in the series according to a consistent procedure;
(b) topomerically aligning each fragment according to a defined set of rules;
(c) calculating steric and electrostatic field descriptor values for the topomerically aligned fragments;
(d) characterising the type and location of features in the topomerically aligned fragments;
(e) entering the field descriptor values in a CoMFA table wherein the field descriptors for each fragment are associated with the unique parameter value for the molecule from which the fragment was derived;
(f) analyzing the table with the CoMFA methodology to derive a 3D CoMFA QSAR model generating coefficients of each field descriptor value in the 3D CoMFA QSAR table;
(g) using the steric field values of the fragments in the CoMFA table and features, searching a heterogeneous compound database for fragments, the database compounds similarly fragmented and the fragments topomerically aligned and characterised by steric and electrosatic field descriptors and features, to identify those fragments having shapes similar ande features to the fragments used to generate the 3D CoMFA QSAR; and
(h) determining the likely activity of fragments identified as being similar in shape by determining the likely activity for each fragment by multiplying the steric and electrostatic field values for each fragment by the 3D CoMFA QSAR coefficients of the similarly positioned fragments derived from molecules in the initial activity series.

3. A computer implemented method for predicting the likely activity of molecules which are likely to share the same type of activity as molecules of an activity series, comprising the steps of:
(a) fragmenting the molecules in the series according to a consistent procedure;
(b) topomerically aligning each fragment according to a defined set of rules;
(c) calculating steric and electrostatic field descriptor values for the topomerically aligned fragments;
(d) characterising the type and location of features in the topomerically aligned fragments;
(e) entering the field descriptor values in a CoMFA table wherein the field descriptors for each fragment are associated with the unique parameter value for the molecule from which the fragment was derived;
(f) analyzing the table with the CoMFA methodology to derive a 3D CoMFA QSAR model generating coefficients of each field descriptor value in the 3D CoMFA QSAR table;
(g) using the steric field values and features of the aligned fragments, searching a heterogeneous compound database for fragments, the database compounds similarly fragmented and the fragments topomerically aligned, characterised by steric and electrosatic field descriptors and features, to identify those fragments having shapes and features similar to the fragments used to generate the 3D CoMFA QSAR; and
(h) determining the likely activity of molecules formed, when fragments from the heterogeneous compound database, identified as being similar in shape and features, are used to replace the fragments from the molecules in the initial activity series, by multiplying the steric and electrostatic field values for each database derived fragment by the 3D CoMFA QSAR coefficients of the similarly positioned fragment derived from molecules in the initial activity series.
